(19) United States
(12) Patent Application Publication
(10) Pub. No.: US 2026/0285703 A1
(43) Pub. Date: Sep. 24, 2026

(54) LOSS-FREE PROCESS FOR PRODUCING CATHODE ACTIVE MATERIAL WITHOUT GENERATING WASTE AND WASTEWATER

(71) Applicant: Thomas KÖNIG, Maierhöfen (DE)

(72) Inventor: Thomas KÖNIG, Maierhöfen (DE)

(21) Appl. No.: 19/479,984

(22) PCT Filed: Feb. 28, 2024
(86) PCT No.: PCT/EP2024/055164

§ 371 Date: Oct. 29, 2025

(30) Foreign Application Priority Data
May 1, 2023 (DE) 10 2023 111 177.9

(51) Int. Cl. C01G 53/44; B01D 25/164; B01D 25/28; B01D 25/32; B01D 37/00; B01D 61/02

(52) U.S. Cl. CPC C01G 53/44; B01D 25/164; B01D 25/282; B01D 25/322; B01D 37/00; B01D 61/027; C01P 2006/40

(57) ABSTRACT

The invention relates to a resource-saving method for producing alkali-metal-containing cathode active materials, which forgoes the use of additional purified water through the use of condensate water from the precursors. The invention also relates to the purification of the alkali-metal-containing washing water that arises during the production of cathode active material. According to the invention, alkali-metal precursor recovered in the process is fed back to the production process.

### CROSS-REFERENCE TO RELATED APPLICATIONS

This application is a U.S. National Phase application of International Application No. PCT/EP2024/055164 filed Feb. 28, 2024, which claims priority to German Application No. DE 10 2023 111 1779 filed May 1, 2023, the entire contents of each of which are incorporated by reference herein for all purposes.

### FIELD OF THE INVENTION

The invention relates to a resource-saving process for producing alkali metal-containing cathode active materials, which does not require the use of additional treated water due to the use of condensate water from the precursors. The invention also relates to the treatment of alkali metal-containing wash water produced during the production of cathode active material. According to the invention, recovered alkali metal precursor is returned to the production process.

### BACKGROUND

Electromobility is heavily criticized due to the lack of sustainability in the production of electric batteries, in particular cathode active materials containing lithium ions. Both the extraction of lithium and the lack of a closed cycle and the limited availability of lithium in particular pose a major challenge for the manufacturing processes. According to the current state of the art, the production of cathode active material cannot be considered as “green technology”. Not only the high energy requirements, but also the high demand for lithium and other metal oxides, such as nickel, cobalt, iron, and manganese, make the future of electromobility very questionable. This invention is therefore of particular importance for the future technology of electromobility. Only by closing the cycle and preventing wastewater and waste from the production process does electric mobility have a future, especially with lithium-ion batteries or other alkali metal ion batteries. This invention enables the waste- and wastewater-free production of cathode active material.

Often, the discharge conditions of production facilities and the limits that must be complied with for alkali metals (especially lithium), nickel, cobalt, manganese, sulfate, nitrate, phosphate, etc. are not feasible with the current state of technology. For this reason, evaporation plants are often used to concentrate the wastewater. The high energy consumption required for this is not in line with the concept of sustainability. Further processing and recovery of alkali metal from the concentrate (bottom product) is also significantly more complex and cost-intensive than the alkali metal-containing solution produced in this invention through optimized material flows.

The task of the present invention is therefore to provide a waste- and wastewater-free process for producing a cathode active material, in which the raw materials end up exclusively in the product by closing the cycle and impurities (such as sulfate, nitrate, carbonate, etc.) are separated and converted into a usable product. The loss of raw materials, in particular alkali metals (e.g. lithium) and other metals contained in the precursor products, should be eliminated or at least reduced to a minimum, and the generation of waste should be prevented. A further objective of the present invention is that the entire production process does not require any additional water, in particular demineralized or deionized water.

### SUMMARY

The task is solved by a method comprising the features of claims 1, 14 and 15. Advantageous embodiments are subject of the dependent claims.

The invention provides a method comprising the steps of:
a) providing one or more metal compounds;
b) providing an alkali metal compound;
c) dehydrating/drying the alkali metal compound and/or dehydrating/drying the recovered alkali metal-rich product and dehydrating the metal compound(s), and using one or more of the resulting condensates or a condensate mixture as wash water;
d) producing a metal oxide lattice and incorporation of alkali metal to obtain a CAM precursor (26);
e) washing the CAM precursor (26) obtained from step d) with the wash water from step c), solid/liquid separation of the washed CAM product (30).

The method further comprises the steps:
f) cleaning the filter device (32) with wash water and returning the rinse water (40) to the wash water reservoir (47);
g) maintaining the alkali metal and acid residue anion concentration constant by removing solution from the wash water reservoir (47) and compensating the volume by adding alkali metal-poor solution (54) and/or condensate(s);
h) treating the alkali metal-rich solution from step g) to obtain an alkali metal-rich material stream (60);
i) dewatering the material stream (60) and returning the recovered alkali metal precursor (62) back to the manufacturing process.

In particular, the invention provides a method comprising the steps of:
a) providing one or more metal compounds 7 in 3;
b) providing an alkali metal compound 5 in 1;
c) dewatering/drying the alkali metal compound 5 in device 9 and/or dewatering/drying the metal compounds 7 in device 11 and/or dewatering/drying the recovered alkali metal-rich product 60, preferably in device 63 or alternatively in device 9, separating the resulting condensates 15, 19 and 64, collection in the condensate tank 55, transfer of the condensate mixture 43 to the wash water reservoir 47, use as wash water 34 for the washing process and as wash water 38 for cleaning the filter unit 32;
d) Production of a metal oxide lattice and incorporation of alkali metal unit 24;
e) Washing the CAM precursor 26 (alkali metal-metal oxide lattice) obtained from step d) in device 28 with the wash water 34 from reservoir 47 from step c), solid/liquid separation of the washed CAM product 30 via a unit 32 and separation of a filtrate 42 and a solid 44;
f) Cleaning the filter device 32 with the wash water 38 from the reservoir 47 and returning the rinse water 40 to the wash water reservoir 47, Maintaining the alkali metal and acid residue anion concentration by removing alkali metal-rich material stream 48 from the wash water reservoir 47 and compensating for the volume by supplying alkali metal-poor material stream 54 and/or condensate 46 and/or condensate 43;
g) Treating the alkali metal-containing material flow 48, 50, 52, 56 from step f) to obtain an alkali metal-rich material flow 60, dewatering the material flow 60 in unit 63 and returning the recovered alkali metal precursor 62, preferably in the mixing device 21, back to the manufacturing process.

In the method according to the invention, it is preferred that the wash water 48 from tank 47 from step f) is subjected to a solids separator 65, whereby the solids separation 65 may also be optional. The solids separator 65 preferably consists of a solids filter 49 (membrane filtration) with a filtrate collection tank 51 and/or a sedimentation tank 69 (e.g. inclined clarifier) and/or a chamber filter press 73 (or decanter). The resulting “solid-free or low-solid solutions” 50 and/or 68 and/or 72 are preferably collected in collection tank 51. FIG. 4 shows the solid separator unit 65 with material flows.

According to an advantageous embodiment of the invention, the solids-free solution 52 is fed to a “concentration unit” 53 and/or a membrane separation process 61 (e.g. diffusion dialysis), whereby the resulting “alkali metal-poor solution” 54 from the concentration unit 53 is fed back to the wash water reservoir 47 and an alkali metal-enriched solution 56 is separated off.

According to the invention, the alkali metal-rich solution 56 is subjected to a membrane separation process 61, whereby an alkali metal-rich/sulfate-poor material flow 60 is obtained, whereby the alkali metal-rich material flow 60 is preferably dewatered and the dewatered alkali metal product 62 of the receiver is dewatered together with the alkaline metal-containing precursor 1 or together with precursor 1 in 9, and the condensate 64 is fed to the condensate collection tank 55 and from there the condensate mixture 43 is further fed to the wash water receiver 47. Depending on the product line or additives used, the alkali metal-rich/low-sulfate material flow 60 may be low in other acid residue anions, such as nitrate, carbonate, phosphate, etc., instead of being low in sulfate.

According to an advantageous embodiment of the invention, the filtering in step e) is carried out by means of a chamber filter press 32. The resulting low-solids filtrate 42b and the return flow 40 resulting from the cleaning of the chamber filter press filter cloths are fed to the wash water reservoir 47.

The alkali metal concentration in the wash water reservoir 47 is kept constant during the process by discharging the material flow 48.

It is also preferable in the sense of the invention that the respective material flows 43, 46, 54, 40, and 42b from the drying, dewatering, separation, and filtration processes are fed in cascade to the wash water reservoir 47. The cascading is shown in FIG. 3. The material flows with the lowest alkali metal concentrations—as expected, these are condensates 15, 19, and 64, or condensate mixture 43 and condensate 46—are introduced at the rear end of cascade 47.3, followed by material flow 54 in cascade 47.2, the material flows 40 and 42b in cascade 47.1 and from there into the washing process reservoir 47.0. The wash water for material flows 34, 38, and 48 is then taken directly or exclusively from 47.0, which has the highest alkali metal concentration. The cascade can consist, for example, of individual tanks (47.3=>47.2=>47.1=>47.0) which are connected to each other via pumps. However, any other type of cascading can also be used. This cascading ensures that the concentration is kept very constant when withdrawing from reservoir 47.0 and that concentration fluctuation due to different inflows are avoided.

The process does not require any externally supplied water, distilled water, or deionized water. Therefore, according to a further advantageous embodiment of the invention, no external deionized water is supplied.

The precursor 7 used in the method according to the invention preferably consists of metal hydroxides comprising the metals Ni, Mn, Co, Al, Fe, Ti, Ta, Zr, Nb or other transition metals or lanthanides, or mixtures thereof, with combinations of Co, Ni, Fe, Mn with lithium (precursor 5) being most preferred.

The alkali metal compound 5 is preferably alkali metal hydroxide or alkali metal carbonate. Lithium as lithium hydroxide monohydrate (LiOH*1H₂O), which has a hydrate water content of approx. 43%, is most preferred. The proportion of Lit is only approx. 16.5%.

The additives 22 for the production of the alkali metal-metal oxide compounds (in particular for lithium metal oxide) are preferably boric acid, aluminum sulfate, zirconium oxide, and aluminum hydroxide. However, other additives, such as sulfuric acid, caustic soda, titanium dioxide, and others, can also be used.

In the method according to the invention, a membrane separation process is also used to obtain an anion-rich material stream 58 and an acid anion-poor/alkali metal-rich material stream 60 for reuse or to close the loop of the manufacturing process. The material stream 58 (acid) is preferably collected in the collection tank 59.

It is also preferred that the condensate water from collection tank 55 is used as feed 57 for the membrane separation process 61 (diffusion dialysis).

The use of the alkali metal-rich precursor 5, e.g. LiOH*1H₂O, as a starting material advantageously leads to the formation of a condensate 15 during the dewatering step 9, which is collected and reused for subsequent washing steps.

Similarly, the dewatering in unit 11 of the precursor 7 produces a condensate 19, which, however, accounts for only a small proportion of the condensates due to its significantly lower water content of only about 0.4% (depending on the product and quality). For the sake of completeness, the condensate 19 is also fed to the condensate tank 55 for further use as wash water. This enables, among other things, the use of other qualities with higher water content. The anhydrous alkali metal oxide 13 from the dewatering/drying 9, the anhydrous me-oxide mixture 17 from the dewatering/drying 11, and preferably additional additives 21 are preferably mixed homogeneously in a mixing device 21 (e.g. with a high-speed mixer). Water-free is understood to mean what is technically feasible and still economically viable. Thus, minimal traces of water are possible as long as they do not adversely affect the quality of the CAM product.

The homogeneous mixture 23 is subjected to a standard sequence of process steps 24 (calcination, deagglomeration, and screening/magnetic separation). These steps are known to those skilled in the art.

The invention also relates to a process plant for carrying out the process as described above. The same features apply to the process plant as those described for the process according to the invention. Reference is made in particular to the list of reference signs and FIGS. 1, 3, and 4.

A further subject matter of the invention is the use of the process plant as described above for the production of an alkali metal-containing cathode active material.

Yet another subject matter of the invention is the use of the process plant as described above for the production of acids, such as sulfuric acid, phosphoric acid, nitric acid, or carbonic acid, whereby this list is not exhaustive and depends on the cathode active material to be produced or the additives used, respectively.

### BRIEF DESCRIPTION OF THE DRAWINGS

FIG. 1 shows a block flow diagram of the material flows in a CAM manufacturing process according to an embodiment of the invention.

FIG. 2 shows a block flow diagram of the material flows in a CAM manufacturing process according to the prior art.

FIG. 3 shows a variant of an embodiment of the invention.

FIG. 4 shows variant of an embodiment of the invention.

### DETAILED DESCRIPTION OF THE INVENTION

The positive electrode in the battery is often referred to as the “cathode.” In most conventional lithium-ion batteries, lithium cobalt oxide is used as the cathode. However, many alternative material systems have been developed and used in recent years.

Due to the high price and low occurrence of lithium, the further development of sodium-ion batteries (SIB) is also being promoted. Sodium-ion batteries have high growth potential due to their superior product properties. In contrast to the limited supply of lithium, 2.6% of the earth's crust consists of sodium. It is also possible to combine lithium-ion and sodium-ion technology to create a so-called hybrid battery. The importance of SIB may well increase in the coming years, and the invention may also be used here and play a decisive role, although the savings with LIB are significantly higher.

In most cases, however, lithium and oxygen are still an essential part of the system. Only the metallic element cobalt is often replaced in whole or in part by other metallic elements such as nickel and manganese. For this reason, most lithium-ion batteries can be described as having a lithium metal oxide cathode. However, there are also systems that use lithium iron phosphate as a material, for example.

Lithium metal oxides are produced as solid powders. When selecting the powder as a suitable material for use as a cathode in a lithium-ion battery (LIB), the microstructure, morphology, particle size, and the degree and type of possible impurities in the powder play a decisive role. These influence the electrochemical properties of the battery that is subsequently manufactured from it.

In particular, the energy density, which is of great importance for the range of electric vehicles, for example, is influenced by the above-mentioned structural parameters.

The microstructure of the cathode must therefore be precisely adjusted. This can be achieved on the one hand by selecting the right raw materials and on the other hand by a controlled manufacturing process for cathode powders. As the term suggests, a lithium metal oxide is a mixed crystal of lithium oxide and oxides of other metals. These mixed crystals are formed by thermally treating a mixture of the individual oxides at high temperatures, typically between 800-1000° C. under specific atmospheric conditions. The individual oxides, in turn, are provided by adding various raw materials to the mixture. The starting materials are often hydroxides or carbonates of lithium and the other metallic elements.

The “Synthesis Report: Cathode Active Material for Lithium-Ion Batteries, Entry ID 506108 (as of Jun. 14, 2023; https://www.forschungsinformationssystem.de/) compares the advantages and disadvantages of the various cathode active materials (NMC, LFP, LCO, and LMNS). Due to the high importance of safety and service life in relation to battery use in electromobility, the layer oxide of lithium, nickel, manganese, and cobalt (NMC) is considered one of the most suitable active materials for lithium-ion batteries. Depending on the materials and additives used, different cations (Li, Ni, Co, Mn, Fe, Al, etc.) and anions (sulfate, phosphate, carbonate, nitrate, etc.) are present in the material flows. However, the principle of the invention is independent of this and can be used for all variants of active materials. Instead of sulfuric acid, only another acid (phosphoric acid, nitric acid, carbonic acid, etc.) is recovered.

Through heat treatment of these starting materials at temperatures of 600-800° C., water (H₂O) or carbon dioxide (CO₂) is released; the remaining oxides later participate in a mixed crystal through further treatments.

Basically, in the production of the cathode, various oxides are obtained from the respective hydroxides or carbonates of the same elements in a first step, and then the desired mixed crystal is produced from these oxides in a second step.

The first step, in which two solids react with each other to form a third solid and gases are released, is called calcination. The second step is called sintering or solid diffusion. Calcination takes place almost independently of time as soon as the temperatures and starting materials required for the reaction to begin are present. Consequently, the first steps of the thermal treatment in the production of the cathode proceed relatively quickly. The diffusion processes for the formation of mixed crystals, on the other hand, are very time-dependent and take significantly longer. In the state of the art, the two steps are usually carried out one after the other in a single process, whereas in others, the calcination products are first cooled and later sintered in a separate thermal process.

In addition to costs and production capacity in a small space, product quality is also one of the success factors for cathode powder manufacturers. This is because, at the same price, battery manufacturers naturally prefer materials with, for example, higher energy density. This can be achieved by making the best possible use of the thermodynamic influences on the calcination and sintering processes.

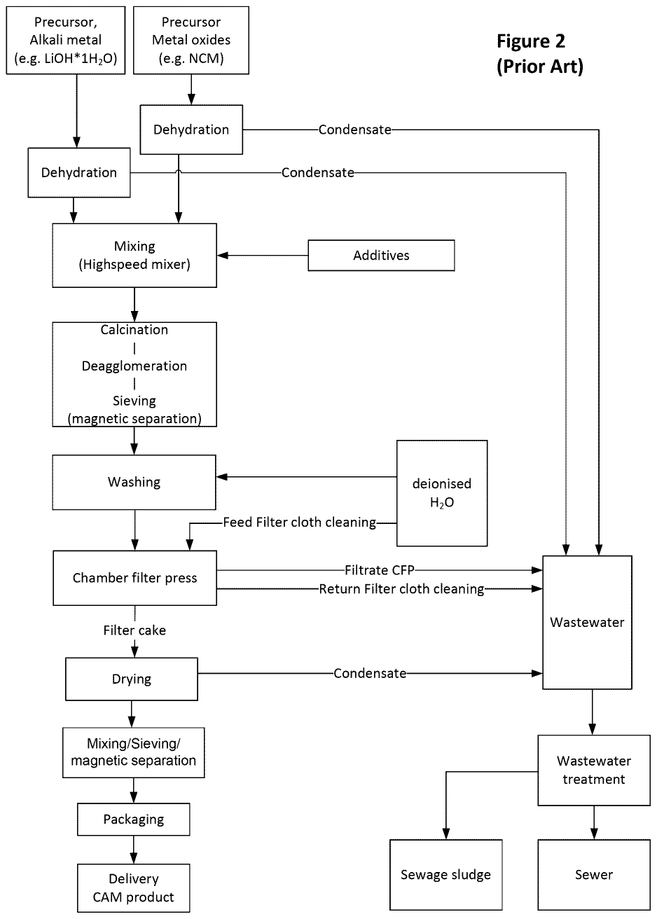

FIG. 2 shows a simplified version of a typical manufacturing process (state of the art) for such cathode materials. Intermediate steps such as screening/magnetic separation and deagglomeration are not listed in full because the resulting minor losses are negligible for the representation of material flows.

The material flows shown in the block diagram, the closed cycle, and in particular the use of condensates instead of pure deionized water eliminate the need for additional deionized water. Instead of many wastewater streams with varying levels of contamination, there is now only a single material flow with constant concentrations of dissolved ions (acid anions, alkali metal cations), which is reduced from 2.5-4 liters per kg of product (CAM—Cathode Active Material) to 0 liters per kg.

The major advantage over conventional processes is the high concentration of alkali metal (e.g. lithium), which makes recovery possible and economical.

Only with the recirculation and reuse of the wash water, which is part of the invention, can a constant product quality be achieved.

Part of the invention is that the concentration of alkali metal (e.g. lithium) or alkali metal sulfate or other alkali metal compounds in the wash water supply is kept constant. This is what makes the process controllable. The resulting constant process conditions enable consistent product quality to be achieved. This is made possible for the first time by this invention.

By recirculating the wash water in reservoir 47 and ensuring that the wash water contains a defined concentration of already dissolved alkali metal (e.g. lithium), the undesirable redissolution of the alkali metal (e.g. lithium) from the metal oxide lattice is prevented. The washing process 28 should only serve to wash out excess alkali metal (e.g. lithium) that is not stored in the lattice. The problems are known in existing plants. A solution to this problem has not yet been found in the prior art.

Redissolution of heavy metals (Ni, Co, Mn, Fe, etc.) is not to be expected due to the pH range of pH 10-12. Therefore, these are not taken into account in the quality of the wash water supply 47.

The concentration in the wash water supply 47 is limited, among other things, by the solubilities, in particular the solubility of alkali metals and alkali metal salts. In the example of lithium or lithium sulfate, Li₂SO₄ has good solubility in water at 342 g/l at 25° C. This results in a maximum concentration of 43.18 g/l of dissolved lithium. The concentration of lithium is also determined by product quality, formulations, precursors used, additives, and other process parameters. Using the example of the lithium-containing cathode active material NMC (lithium-nickel-manganese-cobalt) and the corresponding use of LiOH*1H₂O as precursor 5 and Ni—Mn—Co hydroxide mixture as precursor 7, the concentration is preferably defined as 23 to 25 g/l lithium in the wash water.

The defined concentration of lithium or other alkali metals in the wash water supply 47 is also determined taking into account the technical and economic operation of the subsequent processes for treating the solution and recovering the raw materials, in particular lithium (sulfate).

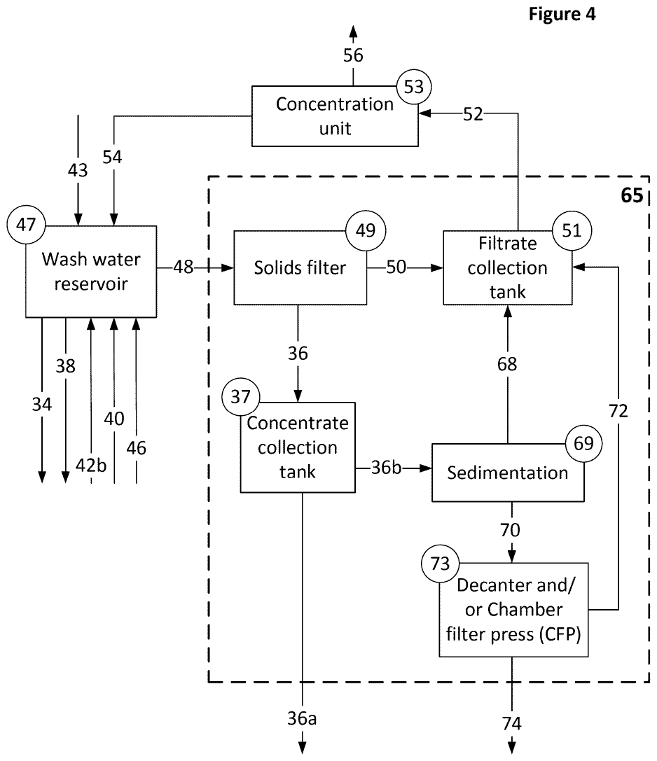

Part of the invention is, among other things, that a solids separation 65 is used to separate possible solids from the discharged wash water 48 upstream of the downstream membrane processes 53 and 61 for the recovery/concentration of alkali metal compounds. The solid separation 65 is shown in FIG. 4 with the possible or combinable process steps. Here, ultrafiltration 49 can be used, among other things, to separate possible solid particles, the resulting concentrate 36 can be collected in the concentrate tank 37, and the material flow 36a can then be fed back to the CAM product 30. This is preferably done by mixing it proportionally with the washed CAM product 30 before unit 32. However, the proportional mixing can also take place directly in unit 28, where the washing process takes place. This ensures that no losses of product, alkali metal (e.g. lithium), etc. occur as a result of returning the concentrate 36a to the manufacturing process and that no additional waste streams are generated. Other solid/liquid separation processes can also be used, such as solid separation by sedimentation 69 (e.g. use of inclined or lamella clarifiers), decanters and/or filter presses 73, or other depth and surface filtration processes. A combination of different solid/liquid separation processes is also possible. The resulting solids 74 are mixed with solids 44 in the collection tank 33 and collected.

The invention mainly relates to the material flow and the return of the concentrate 36a to the process. The return of the solids-rich material flow 36a is preferably carried out by proportional mixing with feed 30, either directly in or even before unit 32. Return and mixing in washing device 28, where the washing process takes place, is also conceivable.

Depending on which alkali metal concentration in the wash water reservoir 47 is considered appropriate or necessary, subsequent concentration can take place, e.g. by means of nanofiltration 53. The alkali metal-poor solution 54 (filtrate) generated from the nanofiltration is returned to the wash water reservoir 47. The concentration of alkali metal salt (e.g. lithium sulfate) in the reservoir 47 is kept constant by discharging the solution 48 (concentrate) enriched with alkali metal salt (e.g. Li sulfate).

The material flows “Rinse water filter cloth cleaning” 40, “Filtrate solid/liquid separation” 42b, “Low alkali metal solution” 54, condensate 15, condensate 19, condensate 46, and condensate 64 can also be collected separately.

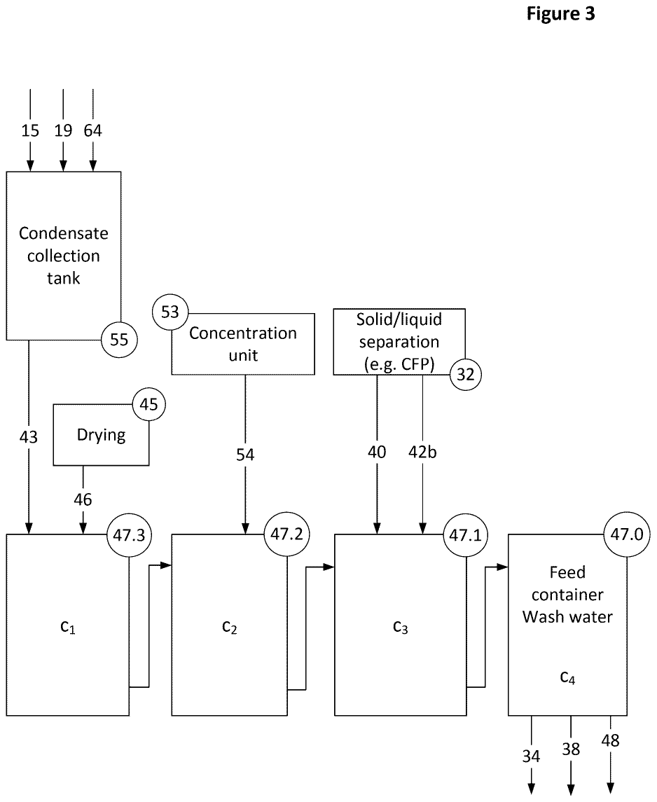

One variant of the invention provides for a cascaded combination of the individual material flows, as shown in FIG. 3. The individual material flows are fed into the respective cascade stage depending on their purity and volume. This variant of the wash water reservoir 47 prevents concentration fluctuations in the water inlet 34 and 38, which makes it possible to run the washing process 28 within a very narrow tolerance range. The constant concentration in the wash water reservoir also offers advantages in the subsequent treatment of material flow 48 and 52.

The amount of condensate 19 from the drying/dewatering 11 of the precursor 7 is so small that it can actually be neglected. However, for the sake of completeness, this is included in the invention because there are many different precursors with different components, different purity levels, and also different water contents.

Part of the invention is that the concentrate 56 from nanofiltration 53 is fed to a membrane separation process 61 (e.g. diffusion dialysis), whereby the material flow 48 from the reservoir 47 can also be fed directly to a membrane separation process or to the diffusion dialysis 61 without prior concentration or without prior nanofiltration 53.

A semipermeable anion exchange membrane is preferably used (acid diffusion dialysis). This membrane allows the H⁺ and SO₄²⁻ ions or acid residue anions to diffuse, while the alkali metal ions (e.g. lithium) are retained. This yields acid 58 in the diffusate, which is used elsewhere as a raw material. The amount of acid produced preferably corresponds approximately to the amount of condensates 15 and 19 produced, which is determined by the volume balance. In the dialysate, we recover an alkali metal-rich solution 60 (e.g. LiOH*xH₂O). This alkali metal-rich material stream 60 is preferably dewatered using a separate unit 63, and the recovered alkali metal-rich and anhydrous precursor 62 is mixed in the desired mixing ratio with materials 13, 17, and 22 in the mixing unit 21. The dewatering unit 63 preferably includes, among other things, a collection tank as a reservoir prior to drying. However, the proportional mixing (blending) and dewatering can also be carried out in the dewatering unit 9, together with the precursor 5 or separately, provided that the higher water content during mixing does not cause any problems.

Another component of the invention is that the deionized water required for the membrane separation process 61 (e.g. diffusion dialysis) is preferably replaced by the condensate water 57 (15, 19, 64) from collection tank 55, thus eliminating the need for additional deionized water. The (deionized) water required for diffusion dialysis can also be replaced or mixed with condensate water on a proportional basis.

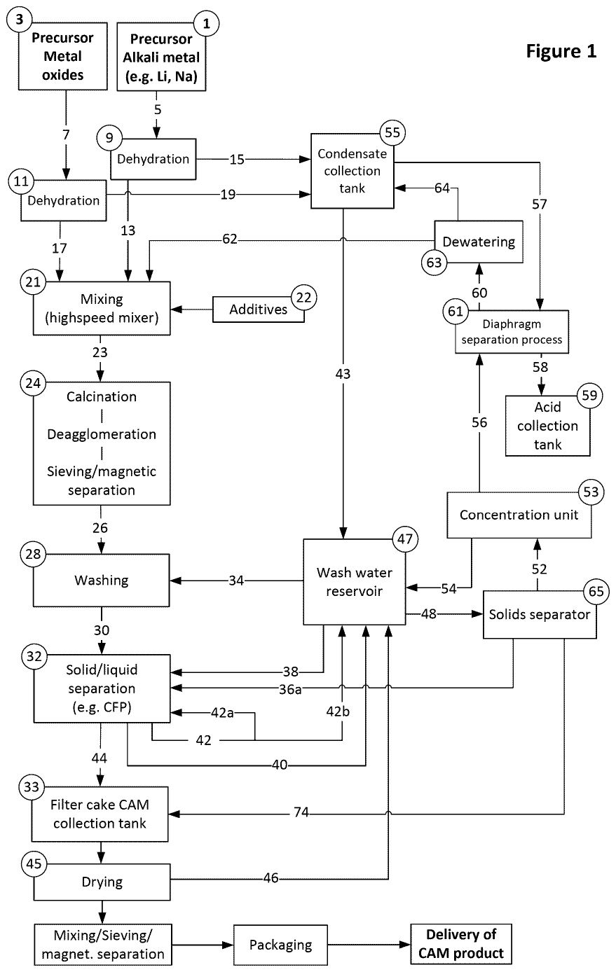

The invention is now explained in more detail with reference to FIG. 1. The figures show:

FIG. 1: A block flow diagram of the material flows in a CAM manufacturing process according to the invention;

FIG. 2: A block flow diagram of the material flows in a CAM manufacturing process according to the prior art;

FIG. 3: Variant wash water supply 47 cascaded, wherein the material flows with the lowest alkali metal concentrations 15, 19, and 64, respectively, and the condensate mixture 43 and the condensate 46 are arranged at the rear end of the cascade 47.3, followed by material flow 54 in cascade 47.2, then material flows 40 and 42b in cascade 47.1, and from there into the washing process reservoir 47.0;

FIG. 4: Option/variant Solids separation 65, comprising solids filter 49, and/or filtrate collection tank 51 and/or sedimentation 69 and/or decanter and/or chamber filter press 73 and/or concentrate collection tank 37.

### LIST OF REFERENCE NUMBERS

1—Feed tank for alkali metal-containing precursor 5
3—Feed tank for precursor 7
5—Alkali metal precursor/alkali metal compound
7—Metal oxide mixture precursor/metal compound(s)
9—Dehydration/drying facility for precursor 5
11—Dehydration/drying facility for precursor 7
13—Anhydrous alkali metal oxide
15—Condensate from drying/dewatering of precursor 5
17—Anhydrous metal oxide mixture
19—Condensate from drying/dewatering of precursor 7
21—Mixing unit
22—Additive reservoir
23—Homogeneous mixture
24—Generation of Me-Oxide lattice and Li intercalation via calcination, deagglomeration, sieving/magnetic separation
26—CAM precursor
28—Washing equipment CAM product
30—CAM product, washed
32—Solid/liquid separation device
33—Solids CAM collection tank
34—Wash water
36—Solid-rich solution (concentrate)
36x—a=Recirculation, b=Further concentration
37—Concentrate/solids collection tank
38—Wash water for filter cleaning
40—Rinse water from filter cleaning
42—Filtrate solid/liquid separation (a=turbidity, b=clear)
43—Condensate mixture
44—Solids (e.g. filter cake, CAM product for drying)
45—Drying/dewatering unit (e.g. filter cake)
46—Condensate from drying 45
47—Wash water reservoir
47.x—Example of cascaded wash water reservoir 47.0 to 47.3
48—Feed solids filter (e.g. ultrafiltration)
49—Solids filter (e.g. ultrafiltration)
50—Solid-free or low-solid solution (permeate)
51—Filtrate collection tank
52—Solids-free solution (feed 53)
53—Concentration unit
54—Alkali metal-poor solution
55—Condensate collection tank
56—Alkali metal-rich solution from concentration unit
57—Condensate water
58—Anion-rich material flow (acid)
59—Acid tank
60—Alkali metal-rich material flow
61—Membrane separation process (e.g. diffusion dialysis)
62—Recovered alkali metal-rich precursor product
63—Dewatering unit
64—Condensate from dewatering
65—Solids separator
68—Clear phase, low in solids
69—Sedimentation (e.g. lamella clarifier)
70—Sediment, high solids content
72—Solids-free or low-solids solution from solids filter
73—Solid/liquid separation (e.g. KFP and/or decanter)
74—Solids (e.g. filter cake) from unit 73

### Description of the Process

Condensate 15 from dewatering 9 of preliminary product 5, condensate 19 from dewatering 11 of preliminary product 7, and condensate 64 from dewatering 63 of alkali metal-rich material stream 60 from the process are collected in tank 55 and (re) used as feedstock for the washing process. The majority of the condensate comes from the drying of precursor 5 and a small portion comes from the drying of precursor 7.

After the CAM precursor 26 (e.g. Li metal oxides or Li metal oxide mixture) has been produced, the reaction product is washed and filtered. Filtering is preferably carried out in a chamber filter press 32 using a filter cloth, although all other filtering methods known to those skilled in the art can also be used. The filtrate 42b from the chamber filter press 32 or the wash water 38 from the wash water reservoir 47 is used to clean the filter cloth. This prevents or reduces the redissolution of alkali metal at the filter cloth/CAM product interface.

The water flows of the condensates 15, 19, and 64 are collected in the condensate collection tank 55, while the filtrate 42 from the chamber filter press and the rinse water return 40 from the cloth wash are collected in the reservoir 47.

The filtrate 42 from the chamber filter press is initially fed into the circuit (material flow 42a) to prevent filtrate contaminated with solids from entering the wash water reservoir at the start (formation of the filter cake, turbidity run). The switchover to the wash water reservoir can also be monitored and controlled by means of sensors (turbidity).

The concentration of alkali metal (e.g. lithium, sodium, etc.) and acid residue anions (e.g. sulfate, phosphate, etc.) in the wash water reservoir 47 is kept almost constant. As expected, when using LiOH*1H₂O as the precursor 5, the concentration of lithium will settle at 23-28 g/l. This concentration range of lithium has a positive effect on the washing process because it significantly reduces the undesirable redissolution of lithium. Ideally, a value of about 25 g/L should be achieved.

Subsequent processing and recovery of lithium or other alkali metals is facilitated by the high concentration of, for example, lithium or sodium in the feed 47.

Further concentration 53 of the resulting alkali metal-containing solution can preferably be carried out by means of nanofiltration or diffusion dialysis. A combination of nanofiltration and diffusion dialysis is preferred.

To avoid contaminating the nanofiltration or diffusion dialysis with solid particles, a solid separation 65 is carried out upstream. This solid separation can comprise microfiltration and/or ultrafiltration as well as other solid separation processes.

Further processing of the lithium sulfate to obtain lithium oxide monohydrate can be carried out, for example, as described in EP 2 762 611.

The solid-rich solution 36 from the solid filter 49 (e.g. micro- or ultrafiltration) can preferably be further concentrated as material flow 36b in subsequent steps, e.g. sedimentation 69 by means of a lamella clarifier or simply in a thickener and subsequent chamber filter press (CFP) or also decanter 73 (FIG. 4). The solids (e.g. filter cake) 74 can also be delivered as a product according to customer specifications, e.g. by means of blending (mixing OffSpec with product). However, it is preferable to collect the solids-rich concentrate 36 from the solids separator 65 in tank 37 and mix it proportionally with feed 30 as feed 36a in device 32.

This can also be done in stages. Since the remaining residual volume is very small, the recovery of alkali metals, in particular lithium, e.g. as lithium hydroxide monohydrate or other lithium or alkali metal compounds, can also be carried out externally.

The process, in particular the material flows, are the actual invention, which enables a closed loop in the manufacturing process of cathode active material and results in virtually no losses. There is no need for additional resources such as deionized water, raw materials, and chemicals for pH correction.

The formulation and precursors used may differ from the variant shown. The additives, as well as the precursors, vary depending on customer requirements.

The invention offers the following advantages:
Consistent and very high product quality.
Controlled process (the sensitivity of the washing process according to the current state of the art is no longer an issue)
No additional resources required (water, chemicals for wastewater treatment, etc.)
100% of the raw materials used end up in the product. No loss of raw materials.
No waste, wastewater, or sludge is produced.
No need for high plant investments, such as evaporation plants for concentrating (e.g. lithium-enriched) wastewater.
No need to discharge wastewater and therefore no conflict with discharge limits.

Cost savings resulting from the invention:
A. Recovery of alkali metals (especially lithium) or precursors by closing the cycle
B. Elimination of wastewater treatment plants or other facilities, such as evaporation plants
C. No costs for wastewater treatment and discharge
D. No costs for disposal of waste/concentrates
E. Recovery of raw material acid (e.g. sulfuric acid)
F. 100% reduction in demand for deionized water
G. No additional costs for acids and alkalis for pH adjustment
H. Based on 2023 prices for raw materials, etc., savings of approximately €2,000 per ton of CAM product are achieved compared to the state of the art.

The points listed result in an expected total saving of around €2,000 per ton of CAM using the example of lithium cathode active material, with the highest savings being achieved by point A and then point B.

1. A method for producing an alkali metal-containing cathode material comprising the steps of:
a) providing one or more metal compounds;
b) providing an alkali metal compound;
c) dehydrating/drying the alkali metal compound and dewatering the one or more metal compounds and/or dehydrating/drying a recovered alkali metal-rich material stream, and using one or more of resulting condensates or a condensate mixture as wash water;
d) producing a metal oxide lattice and incorporating the alkali metal compound to obtain a CAM (cathode active material) precursor;
e) washing the CAM precursor obtained from step d) with the wash water from step c), and solid/liquid separation of a washed CAM product.

2. The method according to claim 216, wherein the wash water from step g) is subjected to a solids separator, wherein the resulting solids-rich concentrate is proportionally mixed with feed and/or solids are mixed with the CAM product.

3. The method according to claim 2, wherein a solid-free solution is subjected to a concentration unit and/or a membrane separation process, wherein the alkali metal-poor solution is fed to the wash water reservoir and wherein the alkali metal rich material stream is separated.

4. The method according to claim 3, wherein the alkali metal-rich solution is subjected to a membrane separation process, wherein the alkali metal-rich material stream is obtained, wherein the alkali metal-rich material stream is dewatered and the dewatered alkali metal precursor is mixed in a mixing unit with an anhydrous alkali metal oxide and/or additives in a desired mixing ratio, and a condensate is fed from a dewatering unit and/or to a condensate collection tank and from there to the wash water reservoir.

5. The method according to claim 1, wherein the solid/liquid separation in step e) is carried out by means of a chamber filter press, wherein a filtrate is circulated at the beginning, wherein a turbidity run is preferably monitored and controlled by sensors, wherein during clear running the filtrate is fed to the wash water reservoir and a rinse water produced during a filter cloth cleaning is fed into the wash water reservoir.

6. The method according to claim 1, wherein an alkali metal and/or acid residue anion concentration in the wash water reservoir and in an extraction/inlet are kept constant by withdrawal and recirculation of treated wash water and/or condensate water and/or condensate from a dryer, wherein the alkali metal and/or acid residue anion concentration can be adjusted depending on CAM product and process parameters, wherein the alkali metal and/or acid residue anion concentration is selected such that redissolution in the washing and rinsing process is as low as possible and precipitation of the components is prevented.

7. (canceled)

8. The method according to claim 1, wherein the metal compound comprises metals selected from Ni, Mn, Co, Al, Zn, Fe, or mixtures thereof.

9. The method according to claim 1, wherein respective material flows from solid/liquid separation, condensate from a collection tank or directly from a drying unit and from a concentration unit are fed in cascade to the wash water reservoir.

10. The method according to claim 9, wherein nanofiltration is used as the concentration unit.

11. The method according to claim 1, wherein acid is recovered a tank and a substance stream low in acid anions and rich in alkali metals is recovered for reuse/circuit closure by means of a membrane separation process.

12. The method according to claim 11, wherein a semipermeable or ion exchange membrane is used as the membrane separation process.

13. The method according to claim 11, wherein a condensate mixture from a collection tank is used as feed for the membrane separation process.

14. A process plant for carrying out the method according to claim 1.

15. The process plant according to claim 14 wherein the plant is configured to produce an alkali metal-containing CAM product and/or to produce an acid selected from sulfuric acid, phosphoric acid, nitric acid, and/or carbonic acid.

16. The method according to claim 1 further comprising the steps of:
f) cleaning a filter device with the wash water and returning rinse water to a wash water reservoir;
g) maintaining an alkali metal and acid residue anion concentration constant by removing an alkali metal-rich solution and compensating the volume by adding an alkali metal-poor solution and/or condensate(s);
h) treating the alkali metal-rich solution from step g) to obtain an alkali metal-rich material stream; and
i) dewatering the alkali metal-rich material stream and returning a recovered alkali metal precursor back to the process.
